(19) United States
(12) Patent Application Publication
(10) Pub. No.: US 2001/0044840 A1
(43) Pub. Date: Nov. 22, 2001

(54) Method and system for real-tme monitoring and administration of computer networks

(75) Inventor: Russell Carleton, Fair Oaks, CA (US)

Correspondence Address: John P. O'Banion, O'BANION & RITCHEY LLP, 400 Capitol Mall, Suite 1550, Sacramento, CA, 95814, US

(73) Assignee: LIVE NETWORKING, INC.

(21) Appl. No.: 09/736,956

(22) Filed: Dec. 12, 2000

Related U.S. Application Data
(60) Provisional application No. 60/170,471, filed on Dec. 13, 1999.

(51) Int. Cl. G06F 15/173

(52) U.S. Cl. 709/223

(57) ABSTRACT

The present invention pertains to a method and system for real-time monitoring and surveillance of a computer network according to a set of business rules that describe system and device operational requirements. The business rules are determined by users and implemented by network administrators so that direct, real-time, on-the-fly secure, interaction with the business rules is provided. The invention provides an interface to apply the business rules to network monitoring so that designated users are notified according to user defined escalation levels when a device violates a business rule.

### CROSS-REFERENCE TO RELATED APPLICATIONS

This application claims priority from U.S. provisional application serial No. 60/170,471 filed on Dec. 13, 1999 incorporated herein by reference.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1 . Field of the Invention

The present invention pertains generally to computer networks, and more particularly to a method and system for remote monitoring and administration of computer networks according to a set of business rules which may be modified in real-time.

2. Description of the Background Art

Establishing a computer network for a business which satisfies both the business requirements and technical configurations within a large network is a complex task. Every bit as complex can be the requirement to provide ongoing surveillance, monitoring, and administration of that network. It is generally incumbent upon the administrator of an established network to monitor network operation in relation to the business requirements for which it was established. The administrator is thereby typically responsible for the resource intensive task of configuring the network for optimum utilization and for ongoing network surveillance to assure that all aspects of the network are operating in accord with business requirements. A large number of users may share in the responsibility for operating the system such that the system administrator may be only one of many parties involved. Network utilization and structure is often complicated because ports within a system often have differing utilization requirements and provide divergent network services. For example, access to word processing and printers within the network may need to be available from 6:00 a.m. to 6:00 p.m. Monday through Friday, while e-mail services generally need to be available 24 hours a day, 7 days a week. A trouble reporting system does not provide an effective means of monitoring status and performance of the system, since reports are usually generated after workflow has already been severely impacted or halted, and rarely do trouble reports disclose performance issues and provide adequate corrective information. Service disruptions can be minimized if the persons servicing the system are provided with immediate notification when the network violates any particular business requirement.

Accordingly, a need exists for a method and system capable of providing timely information to users, administrators, and service personnel about the operation of the network. The present invention satisfies those needs, as well as others, and overcomes the deficiencies of previous solutions.

### BRIEF SUMMARY OF THE INVENTION

The present invention pertains to a method and system for real-time monitoring and surveillance of a computer network according to a set of user defined business rules to which real-time on-the-fly secure interaction is provided. The system comprises client side software which monitors the business network and remote service centers capable of providing additional monitoring and user notifications according to the business rules. The business rules define system and device requirements against which network operation is compared during monitoring and surveillance. Network operations which violate the rules can cause the generation of an alert notification. Notifications are sent to lists of personnel as alerts which are defined within business rules describing methods of notification and notification details, such as notification addressing. Alerts can either be escalated, or reset, as determined by the user responses. For example, if none of the parties listed within a given escalation level respond to an alert within the specified time period, then the alert escalates to a higher level of urgency. Typically, as an alert is escalated, the notification methods and/or the parties to be notified will change to increase the probability of a timely response. For example, if “John Doe was notified of an alert by email and did not respond within the time constraints, the alert would then be escalated to a new notification list and the alert notifications would be posted to the new list. The notification list used for the escalated alert may issue a notification to “John Doe” by phone, or may utilize any combination of parties and methods of notification intended to speed response. Alert escalation provides a mechanism by which a problem can receive increasing levels of attention to expedite and assure proper remediation. Additionally, the data which is collected about the devices on the network is stored within the service center for comparison purposes and to provide historical information.

By way of example, and not of limitation, the invention comprises (i) a monitoring and administration server, and (ii) a client server, both of which are connected to a network, such as the Internet. The client server, which hosts the business rules, is connected to the internal network of a business. The monitoring and administration server preferably communicates over the network with the client server to remotely monitor activity within the internal network of the client, in real-time, and provides escalating notification to the business regarding network issues and device problems via numerous notification methods, such as fax, pager, e-mail, telephone and/or other means of communication. Monitoring and surveillance is performed according to a set of rules established for the business. These business rules can be altered on the fly by an administrator of the system after access verification, which is preferably implemented as a logon sequence requiring proper password entry. The system provides around the clock surveillance of the client network. Additionally, continuous monitoring may be provided through the use of redundant monitoring and administration services. Redundant monitoring provides for network administration and monitoring even if a primary network connection drops or becomes inoperative.

An object of the invention is to monitor, notify, and report on key network devices.

Another object of the invention is to provide the ability to monitor the performance of a business network in a real-time mode through a network accessible site.

Another object of the invention is to provide for real-time definition of business rules which specify desirable network operations to which actual operations are compared.

Another object of the invention is to provide notification of network issues and specific device problems in which network operation violates a set of business rules.

Another object of the invention is to provide multiple notification levels wherein alerts are escalated if a timely response from the alerted parties is not received.

Another object of the invention is to provide the ability to tailor the monitoring and administration services provided to fit specific business organizational needs.

Another object of the invention is to provide the ability to alter selective viewing of device status on the network according to a device hierarchy, such as regions and zones.

Another object of the invention is to provide the ability to scale the services for variously sized client networks and growing networks.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is functional block diagram of a network monitoring and administration system according to the present invention.

FIG. 2 is a functional block diagram showing the authentication and access hierarchy for the client interface according to the present invention.

FIG. 3 is a flow chart showing the addition and monitoring of business rules according to the present invention.

FIG. 4 is a representative logon screen for the monitoring and administration system according to the present invention.

FIG. 5 is a representative home screen being displayed for an administrator that has logged onto the system.

FIG. 6 is a representative index screen showing an index of users.

FIG. 7 is a representative user editing screen which provides for the addition, deletion, and modification of user information.

FIG. 8 is a representative screen showing user permissions within a region tree.

FIG. 9 is a representative screen showing a device index.

FIG. 10 is a representative screen showing a device editing screen.

FIG. 11 is a representative screen showing information being entered on a new device which is to be monitored on the network.

FIG. 12 is a representative screen showing status for a series of devices along with information and ping time graphs for a device currently registering an active alarm.

FIG. 13 is a representative screen showing port traffic graphs for both a monthly and a yearly period.

FIG. 14 is a representative screen providing for region tree management.

FIG. 15 is a representative screen providing for zone tree management.

FIG. 16 is a representative screen providing business rule editing.

FIG. 17 is a representative screen showing a drop-down menu selection of the “notify via” field within the business rule editing screen of FIG. 16.

FIG. 18 is a representative screen showing additional escalation levels which can be defined within the business rule editing of FIG. 16.

FIG. 19 is a representative screen showing devices associated with a selected business rule.

FIG. 20 is a representative screen showing a user notification rules list.

FIG. 21 is a representative screen showing network devices within a region tree.

FIG. 22 is a representative screen showing network devices within a zone tree.

FIG. 23 is a representative screen providing current status and history information for a device being monitored within the system.

FIG. 24 is a representative screen showing current alarms which exist within the network.

FIG. 25 is a representative screen showing a device availability report within a region.

FIG. 26 is a representative screen which depicts the device availability report of FIG. 25, shown in a chart form.

### DETAILED DESCRIPTION OF THE INVENTION

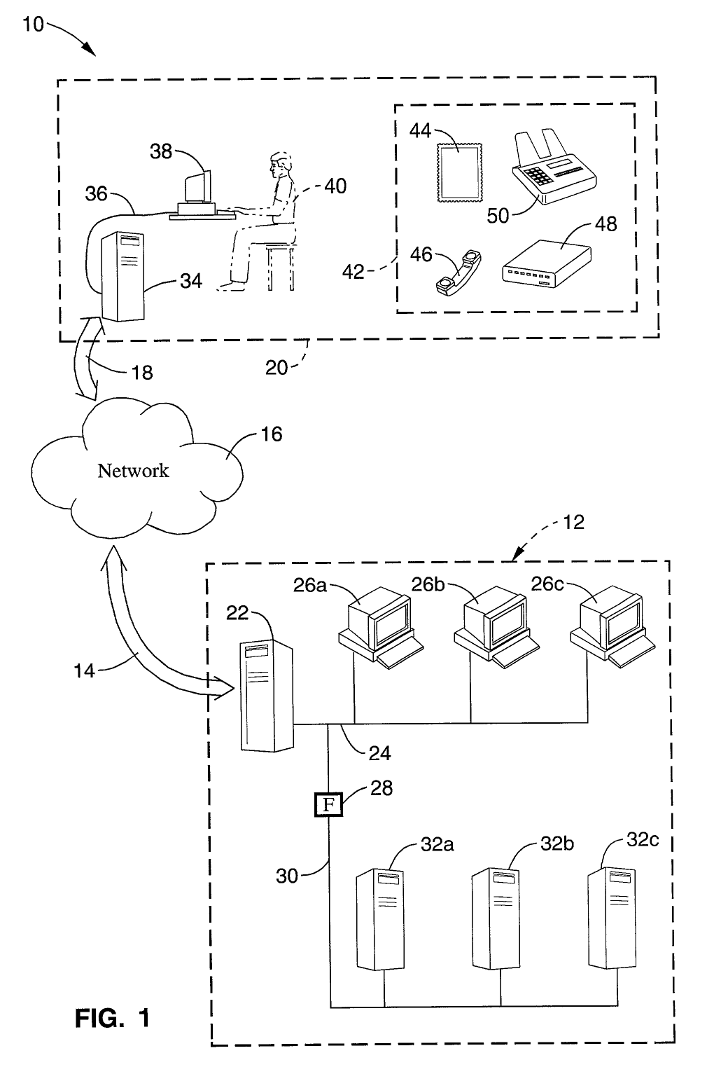

Referring more specifically to the drawings, for illustrative purposes the present invention is embodied in the method and system generally shown in FIG. 1 through FIG. 26. It will be appreciated that the system may vary as to configuration and details of the parts, and that the method may vary as to the specific steps and sequence, without departing from the basic concepts as disclosed herein.

1. System Overview

FIG. 1 shows an embodiment 10 of network topology being monitored by a network monitoring and surveillance system according to the invention, hereafter referred to as “the system”. The system comprises a client network 12 having a connection 14 with a large area network 16, such as the internet. A connection 18 provides communication access through the internet from the system to a remote network monitoring and administration system 20, which may also be referred to as a service center. The client network 12 is shown with a client server 22 hosting the network monitoring application which includes a network device database, a business rules database with a notification list, and programming for monitoring the business network according to the databases. The client server 22 is additionally able to generate alerts according to the notification list when the devices being monitored perform in a manner contrary to the business rules. The client server 22, which is preferably secure, is connected on the internal network 24 of the business. Typically a series of computers, represented by the computers 26a-26c, are also attached to the network. A secure filter router 28 is shown separating a secure IP LAN 30 containing a series of servers/stations, represented by the computer towers 32a-32c. The network shown is representative of a client network and it should be recognized that the system may be applied to monitor any business network of arbitrary topology and size.

Monitoring software hosted on the client server 22 collects status and statistics about device operation in the client network which is communicated via the network 16 to the secure monitoring server 34 within the remote network monitoring system 20. A connection 36 provides communication from the server 34 to a representative computer system 38 shown staffed by an operator 40. Numerous methods of communication exist for notifying client personnel regarding situations within their network, these methods are referred to as notification options. A sample of the many notification options available to the system 38 and operator 40 are shown in the block 42 outlined by the dashed lines which include illustrations of notification by postal mail 44, telephone 46, modem (e-mail) 48, and facsimile 50. It should be recognized that the system is capable of providing a wide array of machine and human generated notification formats, examples include: courier services, e-mail, alpha-pagers, telephone, radio-links, light-wave links, or facsimile. By communicating over the network with the client server, the business network can be remotely monitored in real-time and the business can be notified regarding network issues and device problems by way of the notification options so as to provide around the clock surveillance of the network. Notification can be generated by the remote notification facility without regard to the functional status of the computer network being monitored, as the monitoring software can generate an alert notification to personnel even if the monitored server is inoperative. Additionally, by using redundant monitoring and administration services, continuous monitoring may be maintained even if a connection is dropped between a remote monitoring station and the computer network being monitored. It will be appreciated that a portion of the functions associated with the remote network monitoring system 20 may be performed within the client server 22 or another computer on the network. This arrangement, however, is less preferable as the network and client server must be largely functional in order for the alert notifications to be generated.

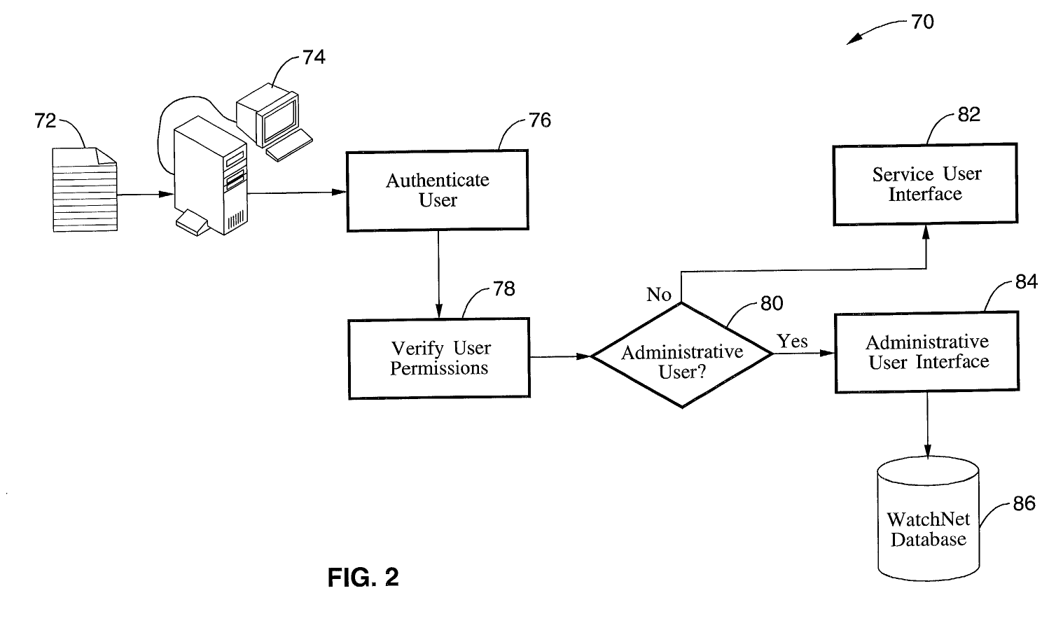

Referring to FIG. 2, the basic interface 70 of the system is shown. The system interface performs the granting of permissions to users for the access and setting of system data and configuration data. A user gains access to the secure server of the monitoring and administration system 74 with a web browser 72 displaying web pages, or by means of an application that provides browser type capabilities. Once authenticated 76, the system permissions 78 and class of the user are determined 80. Illustrated in the flow chart are two classes of users: service users and administration users. It will be appreciated that additional user class distinctions may be utilized for controlling selective access to portions of the system and data contained therein. Service users are provided access through an information display interface 82, while administration users are provided access through an administration interface 84 which provides further information and access to the database 86 so that system settings may be modified. The administrator is preferably provided with direct, real-time, on-the-fly interaction with the database, or databases, and is allowed to modify user information, device settings, port settings, equipment parameters (e.g. such as location), and the business rules for the network. The system monitors each of the network devices which have been defined within the system according to the established business rules.

2. Business Rules and Device Information

Business rules are utilized within the system to specify operational requirements for the network. Information is accordingly required about each of the devices on the network upon which to base network monitoring and administration. The system according to the present invention provides an interface for entering and applying these device definitions and business rules to the monitoring and administration of the network. The system interface is capable of monitoring a variety of devices according to these business rules and notifies designated users of business rule violations within the network. Notifications are preferably generated according to user defined escalation levels in which an alerting notification is escalated to a new set of parties and/or notification methods in the escalation list if a proper response to the condition causing the alert has not been registered within a predetermined interval. The process of escalating the notification typically corresponds with increasing the associated urgency of the alert by using higher priority notification methods, such as a telephone, and by selecting parties for notification which are at higher levels within the organizational hierarchy. The use of alert escalation encourages correction of business rule violations at lower organizational levels, such that persons higher up in the organization need only be notified for grievous violations, and for violations which have not been handled in a timely manner. System alerts which are not properly handled percolate up through prior escalation levels and typically move toward more immediate forms of notification and the alerting of those at higher levels within an organization. The business rules and escalation levels can be expanded to fulfill the requirements of businesses or organizations of any size.

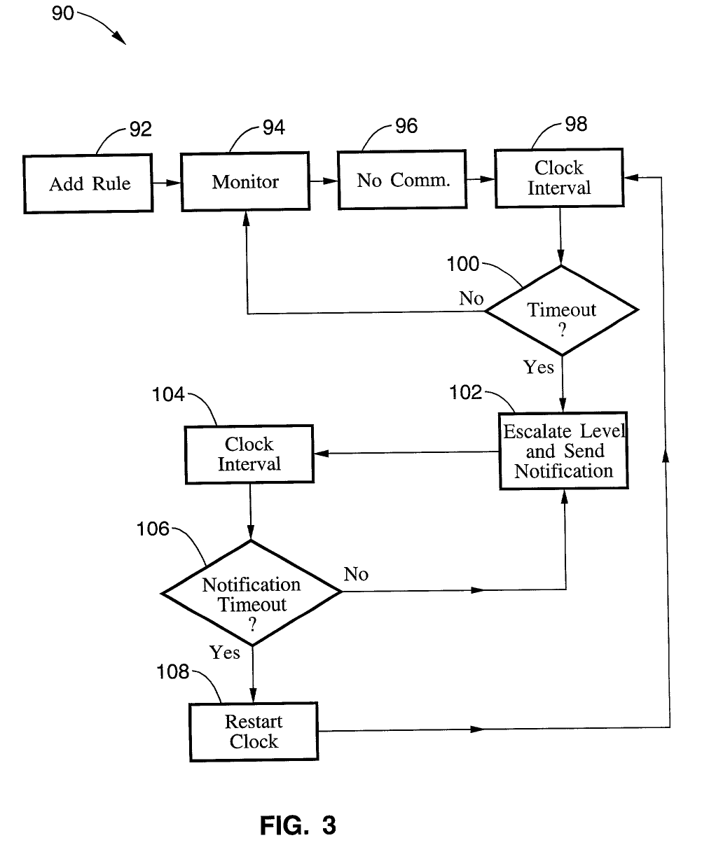

FIG. 3 illustrates interval timing and escalation aspects of the business rules 90. A rule is added 92 to the set of business rules against which the network is being monitored 94. If a device or port is not communicating 96 with the system, then a clock registers the interval 98 of broken communication. The length of broken communication is compared 100 against the time interval specified in the business rule for this device. If the device has not “timed out”, in comparison to the business rules, then monitoring 94 continues. Otherwise, if the time interval specified in the business rule has elapsed, then a notification is generated 102 as an alert escalation from an inactive state. The interval is measured by a clock 104 and the response period checked 106. If the user responds to the notification within the amount of time as set forth within the business rule, the clock is restarted 108 to register the time interval 98, and the device timeout period is checked again 100. If no response to the notification occurs within the proscribed time, then the notification level is escalated 102.

3. On-the-fly Functionality

The system allows users to add, change, or delete business rules at any time. The modifications to the database are instantly applied to system functionality which provides on-the-fly functionality. If desired, each port of every device could be set to respond to its own individual business rule, however, several devices and ports within each system typically are grouped together to respond to a collection of shared rules. The number of business rules within the system is designed to grow to accommodate businesses of any size.

4. User Information

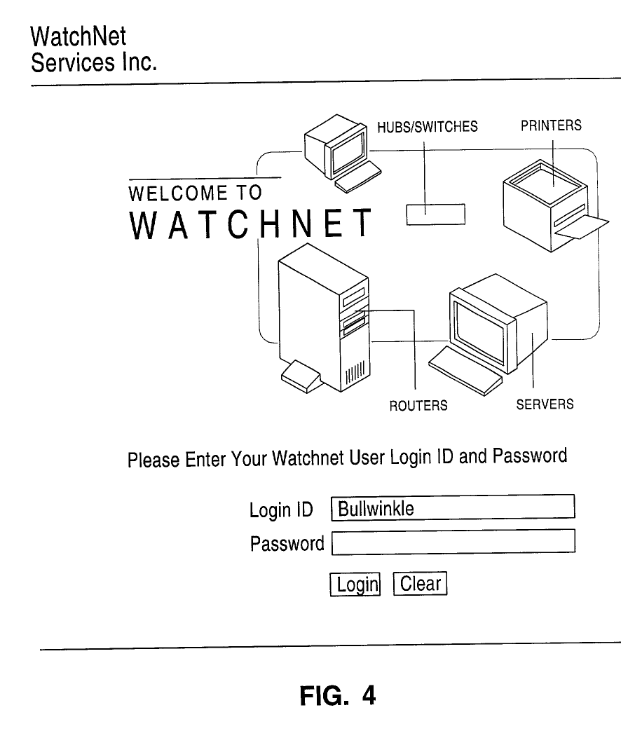

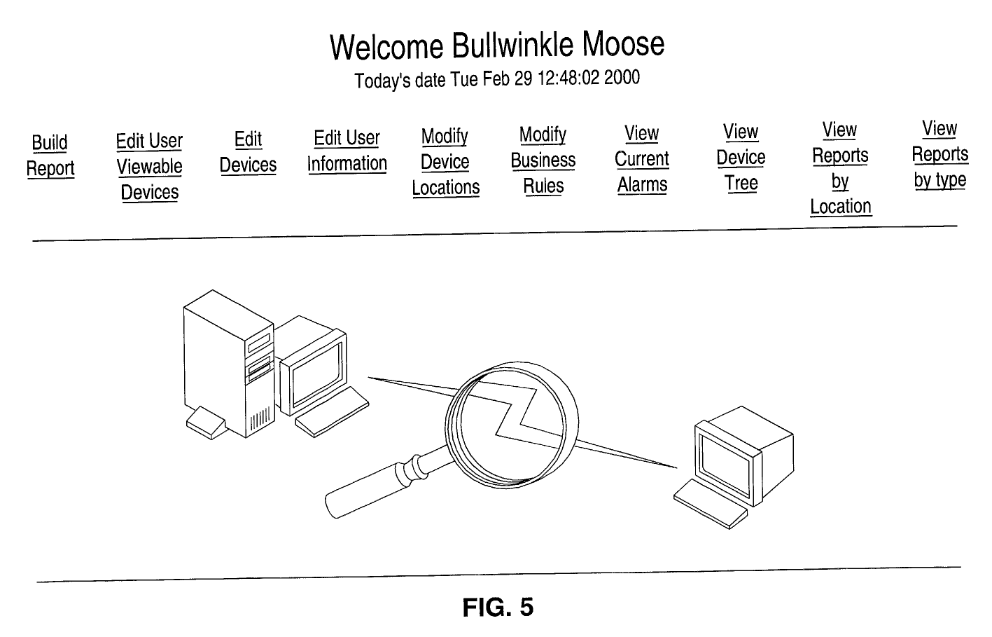

Information is required about the users which are to be allowed access to system information concerning the network being monitored. Preferably, each prospective user is required to log into the system prior to gaining access to network information. FIG. 4 exemplifies a login screen requiring the entry of a user name and an associated password. The login names are typically assigned by the System Administrator. The user, upon gaining access to the system, is offered a series of services which are displayed in the upper portion on the home page of FIG. 5. The following services, as depicted on a menu line in the upper portion of FIG. 5, are provided by way of example and not of limitation: “Build Report”, “Edit User Viewable Devices”, “Edit Devices”, “Edit User Information”, “Modify Device Locations”, “Modify Business Rules”, “View Current Alerts”, “View Device Tree”, “View Reports by Location”, and “View Reports by Type”. It will be appreciated that for the sake of simplicity that typical menu selections and alternative menu selections have not been depicted. A number of the screens associated with these services are illustrated in the figures and described as follows.

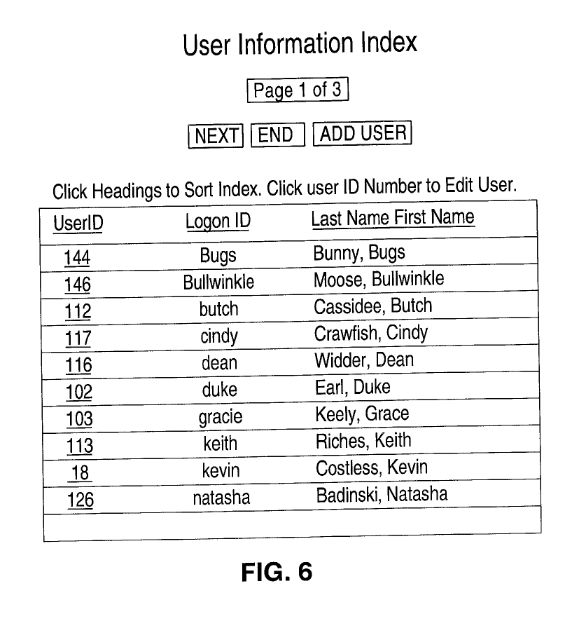

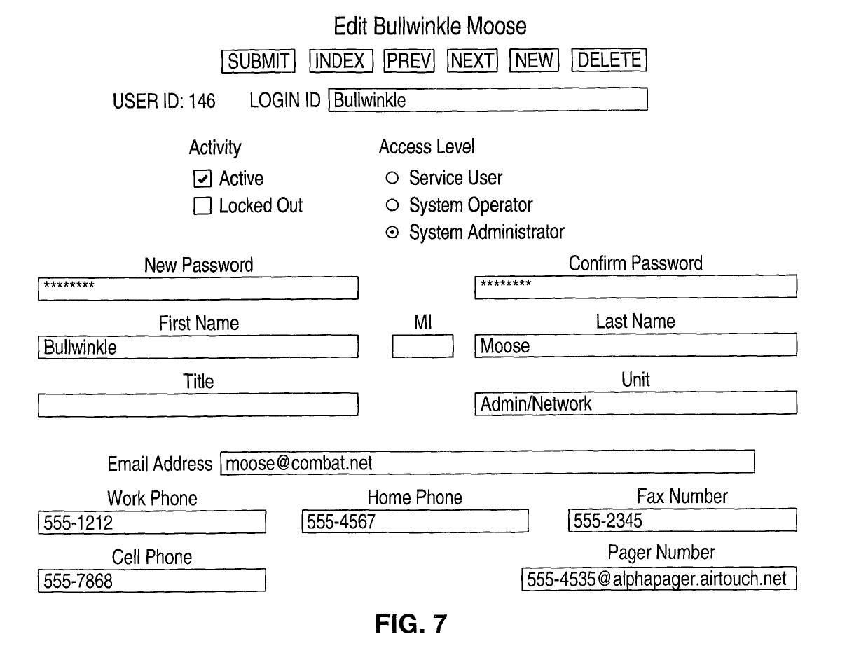

FIG. 6 shows a user information index provided in response to selecting “Edit User Information” from the home page. This page is provided to the system administrator to allow selecting a user whose information is to be reviewed or modified. The list of users is depicted with the name, ID, and logon of each user. The user ID field is shown underlined to indicate the existence of a link such that clicking on a user ID field brings up an editing screen for that specific user. FIG. 7 is a user information editing screen which was opened by selecting user ID 146 within FIG. 6. The system administrator can edit information for any of the users, while a user may edit portions of the information within their own user record. Typically a user record comprises at least: name, title, login ID, user ID, unit/department, activity level, system access level, email address, home phone, cell phone, pager number, and facsimile number. An example of system access levels utilized within the embodiment are Administrator, Service User, and System Operator. Additionally, users may be set as “active” users which are to be granted system access, or as “locked out” users which are prevented from accessing the system until the system administrator redefines them as active users.

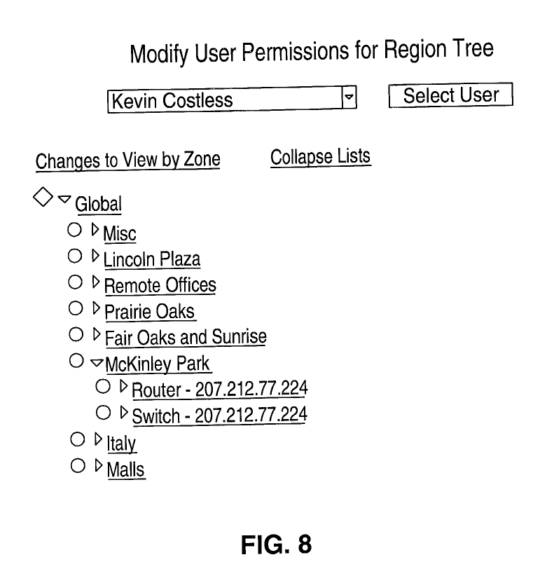

The “Modify User Permissions” screen of FIG. 8 opens when a system administrator selects “Edit user Viewable Devices” from the home page. From this screen the Administrator is able to set access permissions for a particular user in relation to devices being monitored within portions of the network, herein arranged in a hierarchy by network region. The access permissions to the regions and devices are preferably represented graphically on the screen, such as by color. The illustrated embodiment of the present invention utilizes a red selection dot to indicate that no access is available, a green selection dot to represent that access is available, and a grey selection dot to represent that permission is inherited from the previous level in the hierarchy.

5. Network System Information

Information is required about the devices and ports within the system and for defining the business rules against which these devices and ports are to be compared. Information can be entered into the system database with command line responses, menus, and other data entry methods. The following exemplifies the types of information to be entered by the system Administrator:

(a) Device and port information

(b) Devices which are associated with a business rule

(c) Times and days of the week when each business rule applies

(d) Person/s to be notified at each escalation level

(e) Notification methods for notifying each person

(f) Amount of time to wait prior to notification at each escalation level

(g) Amount of time allowed for each party to acknowledge a notification

(h) Amount of time each party is given for clearing an alert

6. Editing System Devices

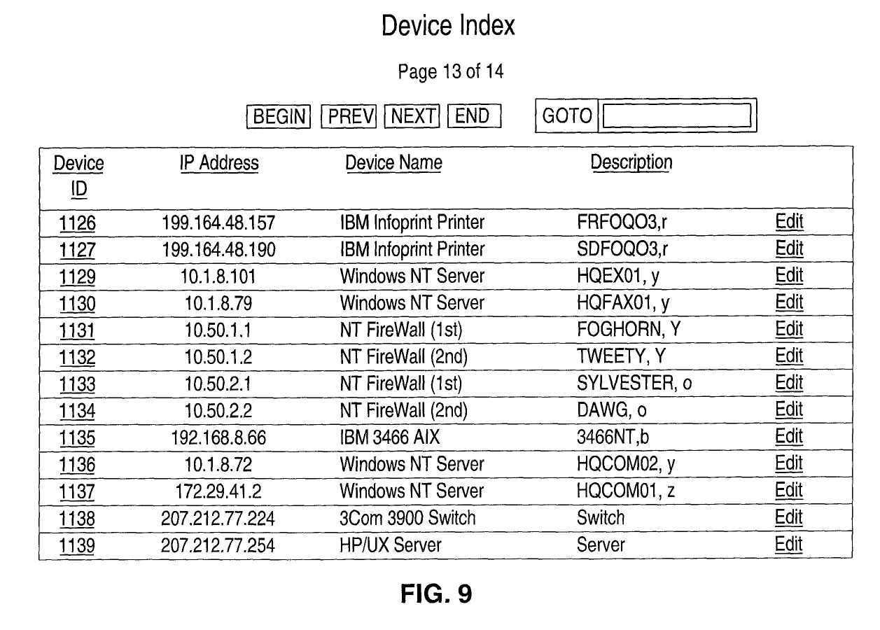

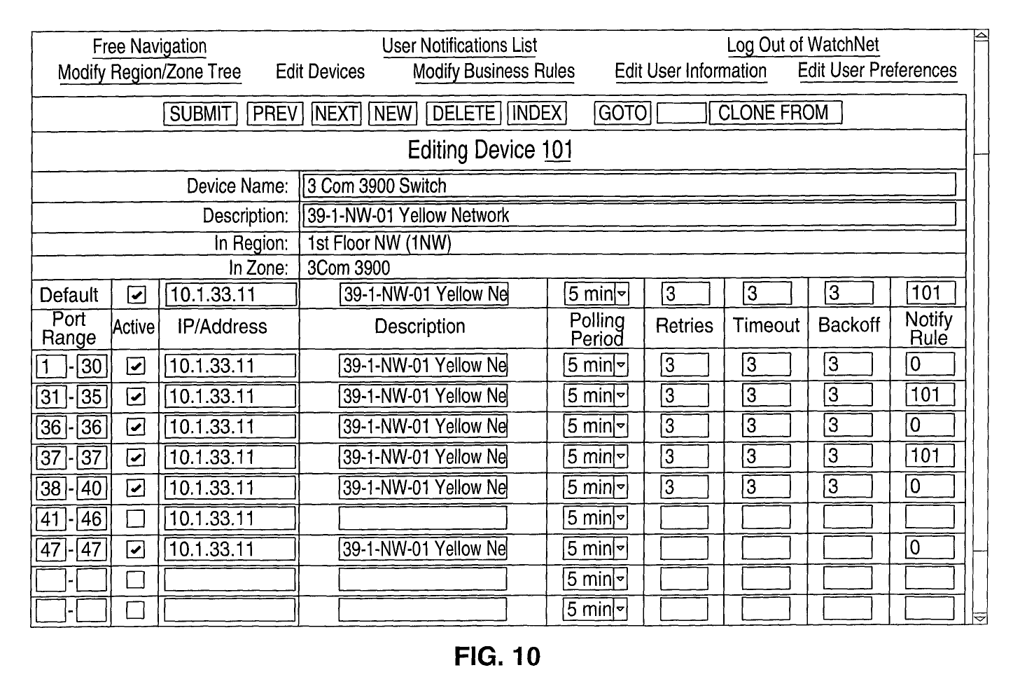

The device index screen of FIG. 9 opens when the link “Edit Devices” is selected from the home page. The index of devices provides a list of network devices and can preferably be sorted on any of the columns, or which may alternately be searched. The device IDs listed in the lefthand column are provided as hyperlinks to open the status screen of the selected device. Device information for any of the indexed devices may be edited by clicking on an associated “EDIT” hyperlink to open a device editing screen for a particular device, such as shown in FIG. 10. The business rule attributes of a device as exemplified by the system embodiment comprise the fields “Notify Rule”, “Port Range”, “Active/nonactive”, “IP Address”, “Description”, “Polling Period”, “Retries”, “Timeout”, and “Backoff”. It will be appreciated that each device need not adhere to a single business rule, as constituent ports thereof may be set for monitoring according to different business rules. Individual ports to be associated with an inactive state are preferably set for business rule zero when they require downtime or when the issuance of condition alerts is to be otherwise deferred. The system monitors adherence to business rules by periodically polling a device according to the user selected “Polling Period”. A “Retries” value sets the number of times to poll an unresponsive device, or port, prior to concluding that it is currently inoperative. A “Timeout” value determines the amount of time that should be allowed for a polling reply. A “Backoff” value allows selecting the delay time between polling attempts. Table 1 lists the functions of each button which is represented within the “Editing Devices” screen of FIG. 10, while Table 2 lists each field therein.

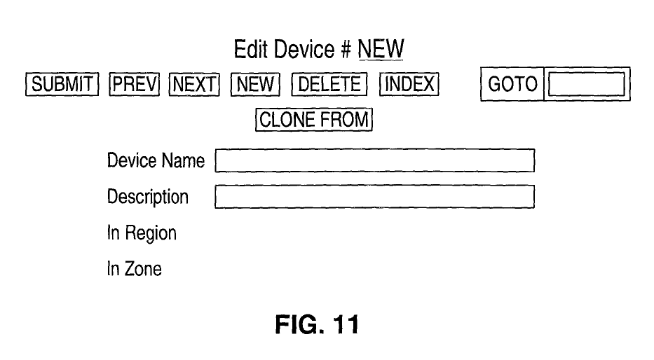

Clicking on “New” from the editing devices screen of FIG. 10, followed by “Submit” will cause a new device number to be generated and the screen of FIG. 11 to open allowing a new device to be defined. Preferably, a cloning feature is provided wherein device information for new devices may be cloned from an existing device, as selected by clicking on “Clone From”, to which modifications may then be applied. The blank fields “In Region” and “In Zone” are filled in automatically upon entering the data for the new device. It will be readily understood that the information collected within the described screen can be organized and collected in a variety of ways.

7. Current Device Status

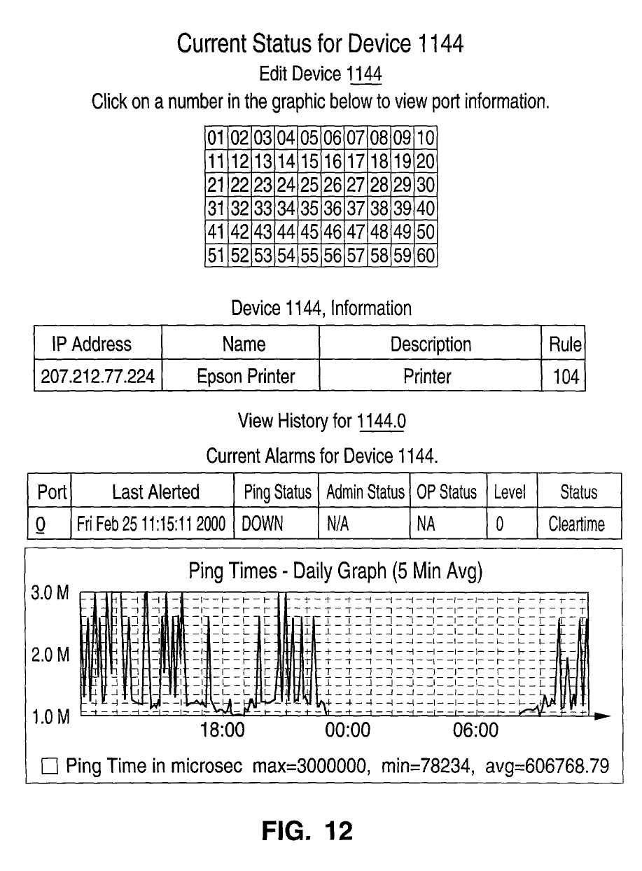

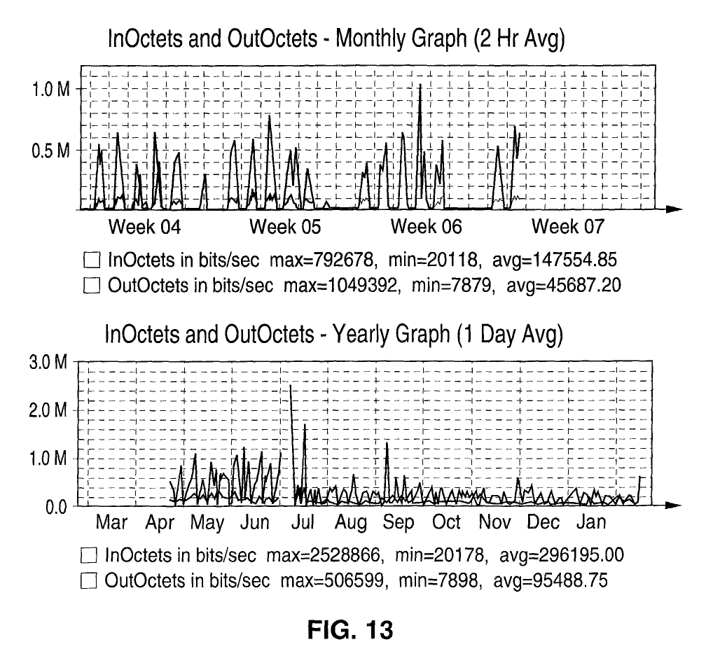

The current alarm status screen of FIG. 12 opens when the link “View Current Alarms” is selected from the home page. The alarm status screen for a device within the system preferably comprises a port selection grid, device information, device alarms, and ping related information, such as ping response graphs from the device. The current status is delivered in real-time by the system so that the user or administrator can monitor actual status and keep updated on changes. The user may select a port number within the grid at the top of FIG. 12, numbered from “01” to “60” to select a port for which additional information is desired. Upon selecting a port, the graphs of FIG. 13 are displayed. The graphs are “InOctet” and “OutOctet” traffic graphs for the particular port. The graphs preferably span an interval of a month (upper graph), and a year (lower graph). The graphs depict the level of port activity over the span of time specified. Referring again to FIG. 12, if any current alarms exist within a device, they are displayed in a block of “Current Alarms” which provide information about the specific alarm. The port number generating the alarm is specified in a “Port” field and the send time of the most recent notification on the alarm is provided in a “Last Alerted” field. A “Ping Status” field indicates if the selected device is responding to the pings. An “Admin Status” field indicates how the device is configured comprising the states of “Up”, “Down”, “Test”, “NA” (not applicable). An “OP Status” field denotes if the device is responding to the SNMP agent, with the possible states being given as “Up”, “Down”, “Test”, or “NA”. A “Level” field indicates the escalation level for the alarm, while a “Status” field displays the current status of the device, such as “Alarm”, “Cleartime”, and “Acknowledge”.

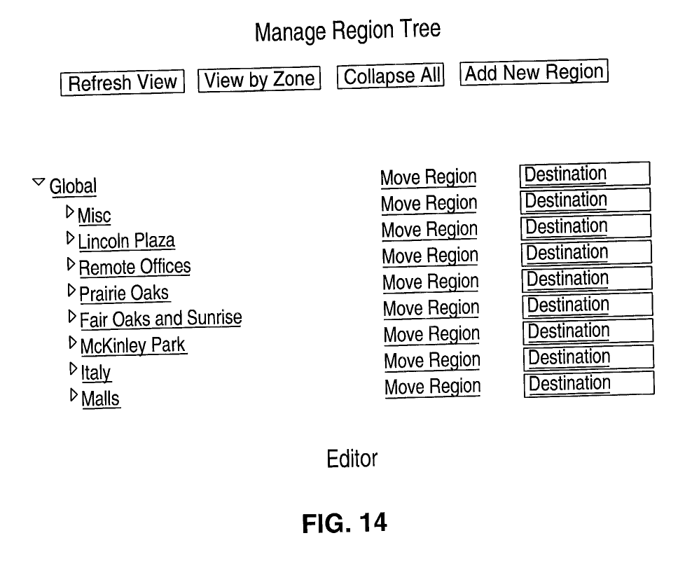

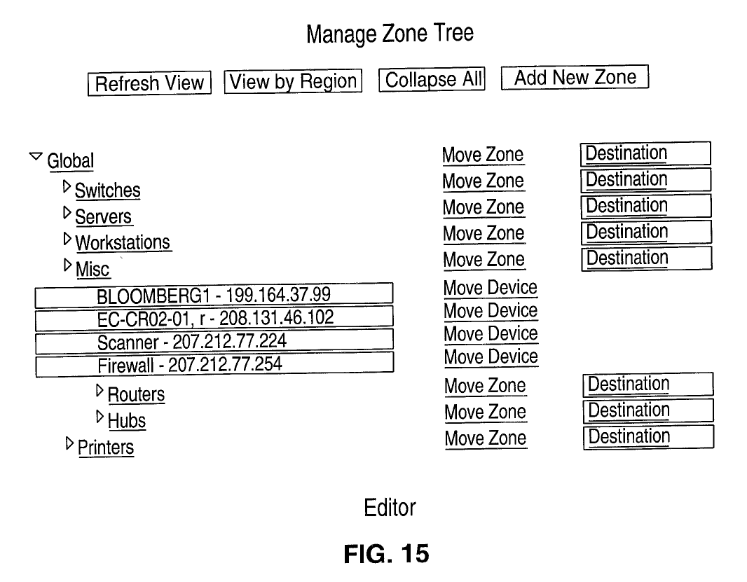

Devices on the network may be organized by either “Zones” or “Regions”. Using regions, the devices are organized by geographical region, while zones provide organization by type of device, such as routers, switches, servers, and so forth. An administrator typically defines the regions and the hierarchy of devices being monitored within the system. Regions are generally defined as actual geographical or physical locations under which a series of locations and devices may be contained. For example, the names and numbers of buildings may be employed at one level of the hierarchy, while building floors or rooms may be utilized subordinate to that level in the hierarchy, and a series of devices further subordinated thereunder. A similar hierarchy of device types may be organized by zone. FIG. 14 illustrates a “Manage Regions Tree” screen which contains triangular icons that are manipulated for controlling tree expansion and contraction. Clicking on a horizontal arrow causes the selected device level to be expanded and the arrow to subsequently face downward. Clicking on a downward arrow causes contraction of the tree again. Selecting the collapse all button causes all the hierarchical levels within the screen to contract to a highest level state. New devices are entered within the present embodiment by default to the category “Global” until they are organized into a desired region or zone with the device editor. The “Manage Region Tree” screen of FIG. 14 additionally appears upon the submission of a new device for monitoring. The region tree displays the devices by region and allows the definition of new regions and the moving of regions to new destinations. Additionally, the user may toggle to the “View Zone Tree” screen of FIG. 15, by clicking on the “View by Zone” button. The zone tree is shown partially expanded as the result of the user clicking the arrow for the “misc.” zone to expand that portion of the hierarchy. A similar expansion of nested levels may be performed within the regions of the “View Region Tree” of FIG. 14. Table 3 and Table 4 list the functions of each button and field link within the view trees of FIG. 14 and FIG. 15, respectively.

8. Modifying Business Rules

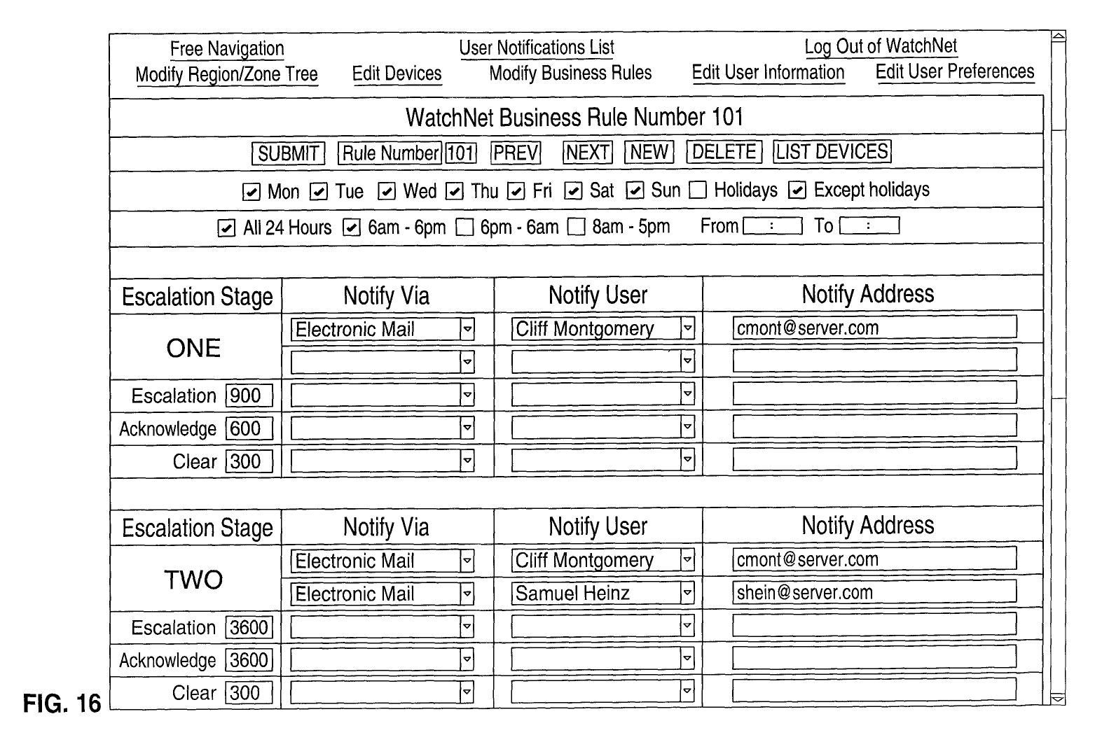

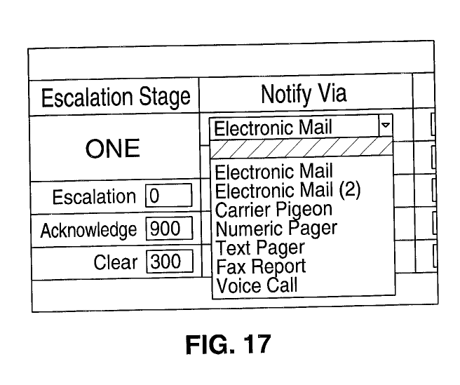

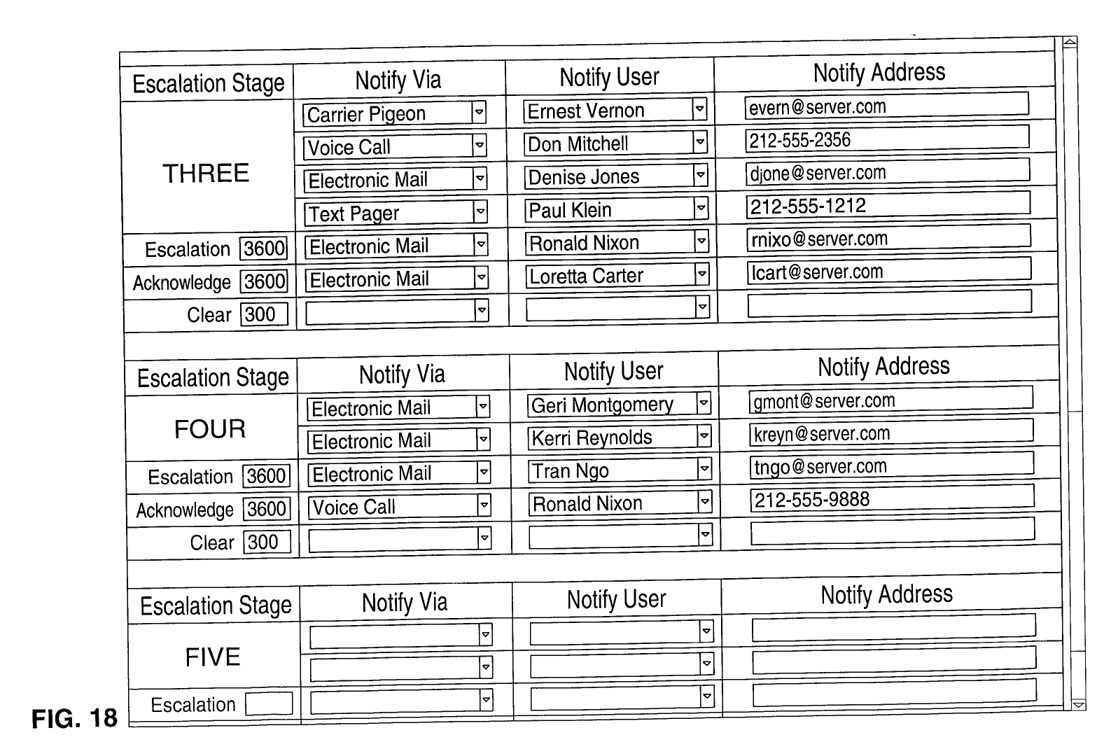

Business rules contain the rules against which the devices defined for the network are compared to determine violations. The business rules preferably include a notification list specifying personnel to be notified if business rules are violated, however, the notification list may alternatively be separately retained within the system. An entry screen for business rules is illustrated in FIG. 16, which is provided by way of example and not of limitation. Administrative users may select a business rule whose elements are thereafter displayed and may be modified. This screen contains a row of buttons that aid navigation within the business rules and allow for adding, deleting, and listing of the devices associated with a rule. Within the business rule editing screen, the user may establish the applicability of a rule based on days of the week and time periods. A notification list is herein associated with each business rule, although alternatively the business rule database may be separated from the notification list to allow the same set of notifications to be utilized within different business rules. Notification information is entered for each escalation level (escalation stage one and stage two are shown) which determine the escalation timing, who is to be notified and by what method they are to be notified. Selection of a notification method is shown in FIG. 17, wherein a discrete value field on the screen is populated by selecting an entry from a drop down list for the “Notify Via” field for an escalation level within a business rule. The business rule modification screen of FIG. 16 shows two levels of escalation, however, any number of levels can be supported within the system. FIG. 18 illustrates the business rule modification screen having been scrolled down towards deeper escalation levels.

Within each escalation stage, (given as 1, 2, 3, . . . n) a set of time intervals determines system alert escalation in response to system conditions. The fields “Escalation”, “Acknowledge”, and “Clear” are provided whose time values are given in milliseconds. The setting of escalation time determines the amount of time a non-functioning device can remain at this escalation level before the alert is escalated to the next level. The escalation clock runs from the first time a device reaches the escalation event, after which it is reset and restarted with each acknowledgment of the alert. The escalation interval field helps to ensure that an alert is not escalated while a person is working on a device. The “Acknowledge” interval is the amount of time a notified user is given to acknowledge the alert before it is escalated to the next level. The acknowledgement interval ensures that the alert will be acted upon and not ignored as the result of a party being currently unavailable. The “Clear Alert” interval is the amount of time over which verification of correct device operation is required prior to removal of the alert condition.

The remote network management system preferably maintains a notification list and business rules associated with the client network for monitoring the client network directly. Direct monitoring of the client network from an external device provides beneficial notification of network errors even when the client network itself is partially or fully disabled and is unable to generate alert notifications. The extent and nature of the databases on the remote network management system can take a number of forms. Preferably, the databases (devices, business rules, and notification lists) which are maintained on a server within the client network, or portions thereof, are mirrored within the server of the remote monitoring station, so that the remote monitoring station has a notification list and escalation provisions which match the client network. This redundancy allows an operator at the remote network management system to provide comprehensive aid to a user while alleviating confusions since both parties have access to identical information.

Specific individuals, or a collection of individuals, within an organization are typically selected for notification when an alert condition arises. A series of fields allow the selection of who is to be notified and how they are to be notified. The field “Notify Via” provides a drop-down list which displays the available notification methods within the system. Any variety of notification types can be supported within the system, for example: “Electronic Mail (2)”, “Alpha-Pager”, “Numeric-Pager”, “Facsimile”, and “Voice Call“. The default notification method is preferably set to “Electronic Mail (2)”, as this is a good starting point for the handling of low level alarms. From the “Notify User” field the name of a user is selected from a drop-down list, or entered manually. The specific user will receive notification when an alert occurs at this escalation level. Any number of users may be notified within a particular escalation level, as defined by the number of entries provided. The “Notify Address” field is required to coincide with the notification method and address; if they do not coincide, then a red border appears around the notification address and requires that the address be corrected. Preferably, a selection of “Electronic Mail (2)” provides an optional address which is not required to coincide. Administrative users may leave this field blank to have the system load the address field with default user information from the database according to the specified notification method. It should be appreciated that addressing for user notifications can alternatively be retrieved from separate databases outside of the software and databases comprising the monitoring and administration system. The system is adaptable to organizations of arbitrary size as it can support a virtually unlimited number of users and escalation levels.

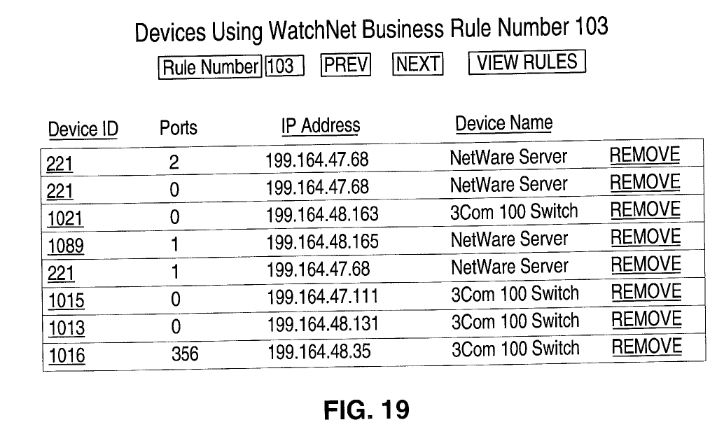

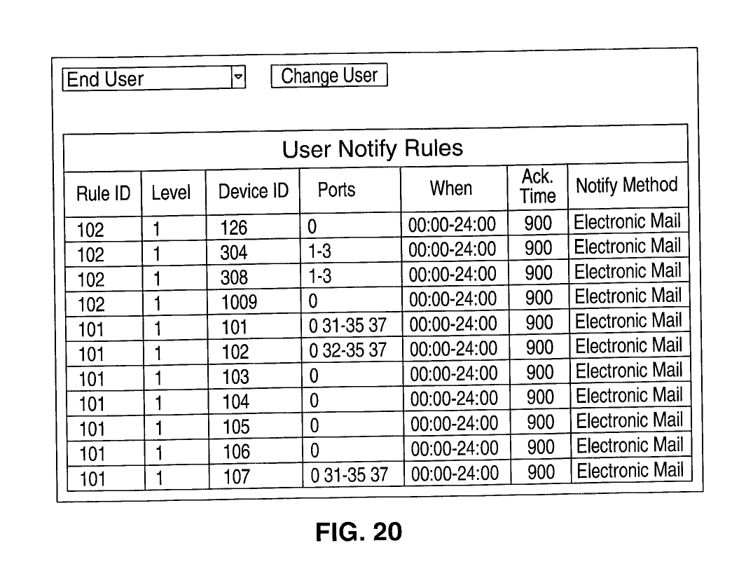

Referring again to the “Modify Business Rules” screen of FIG. 16, the functioning of the buttons are listed in Table 5, and field descriptions are given in Table 6. One of the selection is “List Devices”, which provides access to the “Devices Using Rules” screen shown in FIG. 19 which lists by device ID the devices using this business rule and information about the device. Users can view, add, or remove devices associated with each business rule. Notification rules may also be viewed according to user, a “User Notify Rules” screen is shown in FIG. 20, wherein the rules associated with a selected user are displayed.

9. System Reports

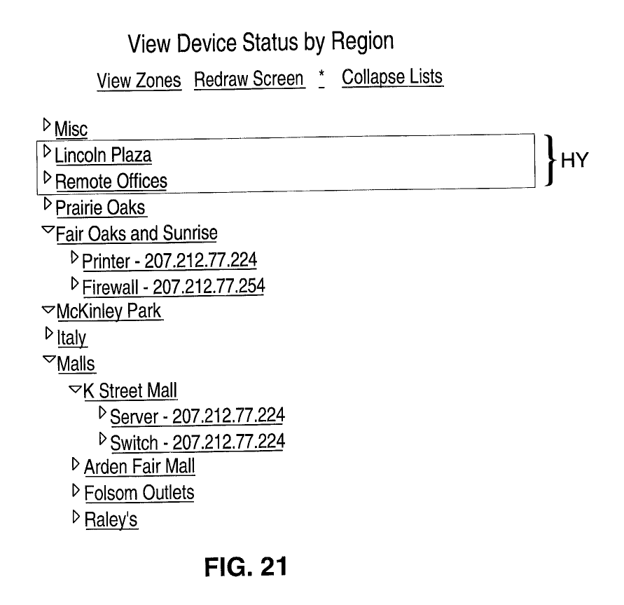

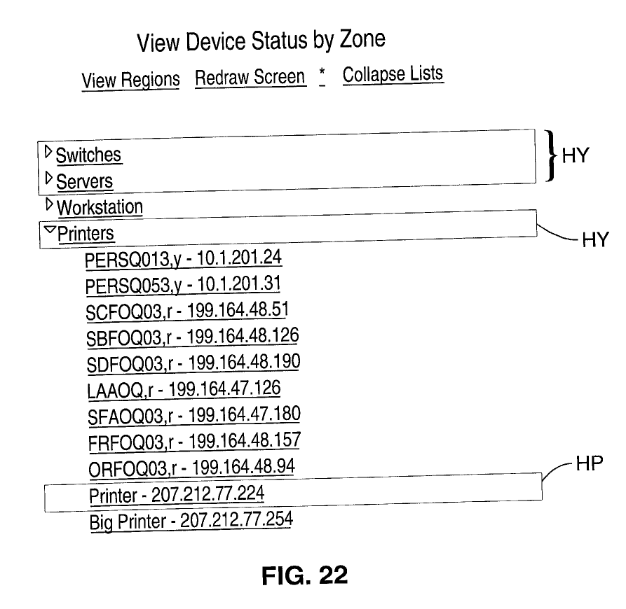

The monitoring and administration system allows viewing of system information and provides variously formatted reports of status and history within the system. Accessible upon login are a “View Device by Region” screen as exemplified by FIG. 21 and a “View Device by Zone” screen as exemplified by FIG. 22. Each of these screens, which are shown having at least one section expanded, provide a hierarchical view of the respective regions or zones which contain devices defined within the system. Entries within the tree are preferably highlighted in colors to indicate alarm status within the respective zone or region. In FIG. 21, both “Lincoln Plaza” and “Remote Offices” are highlighted to indicate that alarm conditions exist within those regions. In FIG. 22 the headline “Printers” and the specific device “Printer 207.212.77.224” are highlighted to indicate the cause of the current printer alarm. Preferably, the alarm indication at a hierarchical level, such as “Printers” is distinguishable from the indication used for a device, such as “Printer 207.212.77.224” by highlighting in a different color. The described embodiment denotes alarm categories by yellow highlighting and specific devices as pink highlighting.

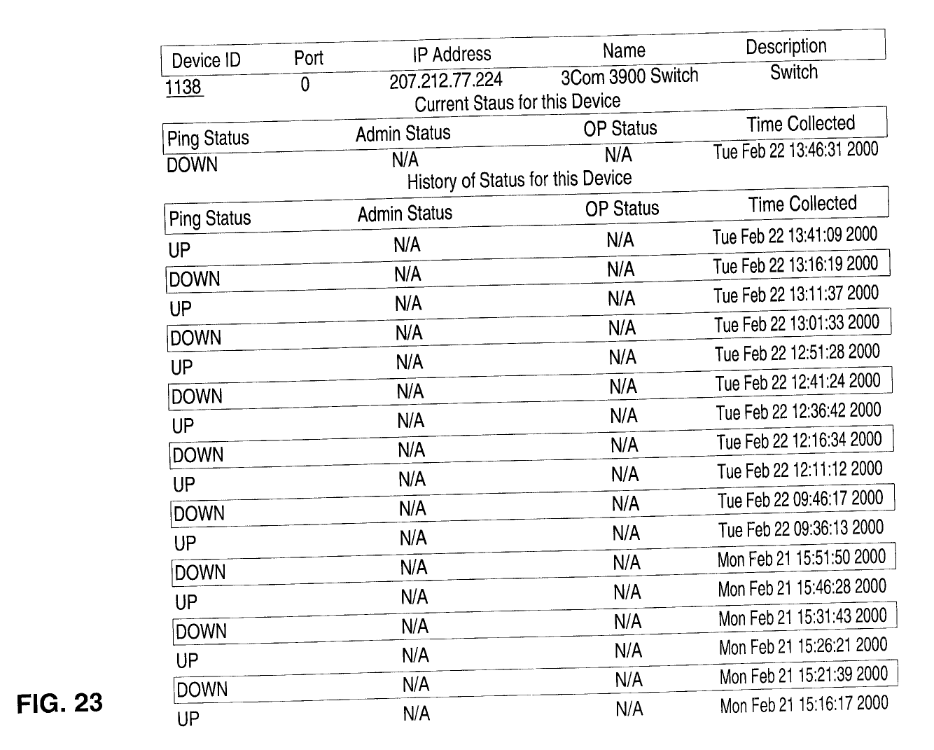

FIG. 23 is a “History of Status” screen for the selected device which is preferably activated by clicking on the “View History Link” within the “Current Status” page. The screen contains device information, current status of the device, and a history of the previous status states of the device. A new line is added to the history on each transition of status for the device, and the history can be maintained for the device from the time it is added to the device database.

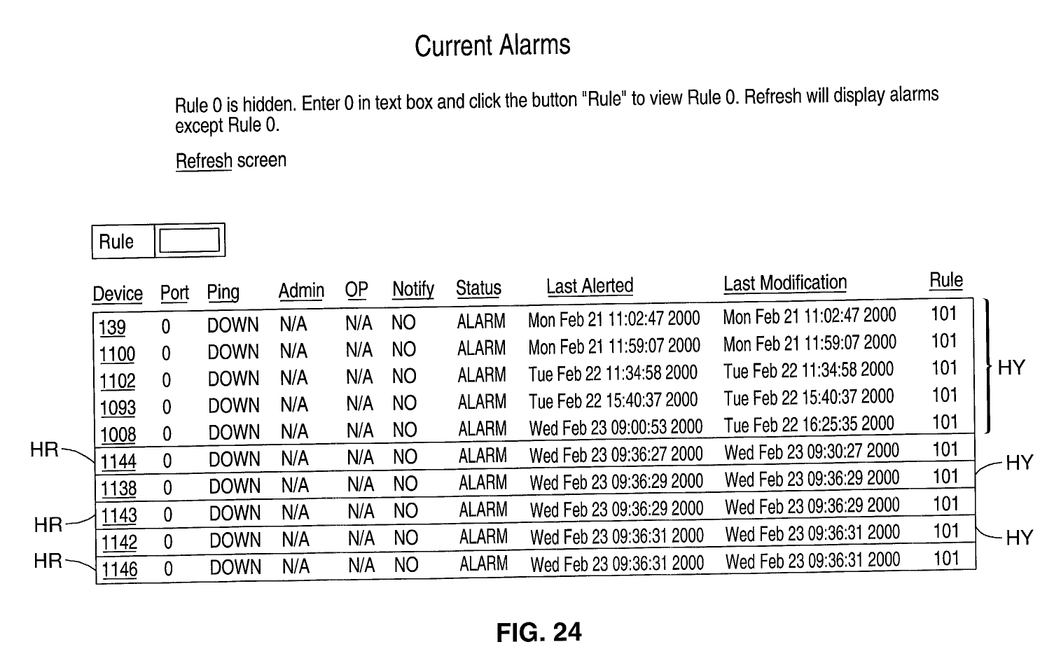

A “Current Alarms” screen of FIG. 24, provides information on all current alarms by device number which currently exist within the system. Preferably, the entries on the screen are coded, such as by colored highlighting, to indicate the business rule being violated by the device, or severity of the condition. In addition, by clicking on the header of any column within the list, the entries within that column are sorted, such as by toggling between ascending order and descending order.

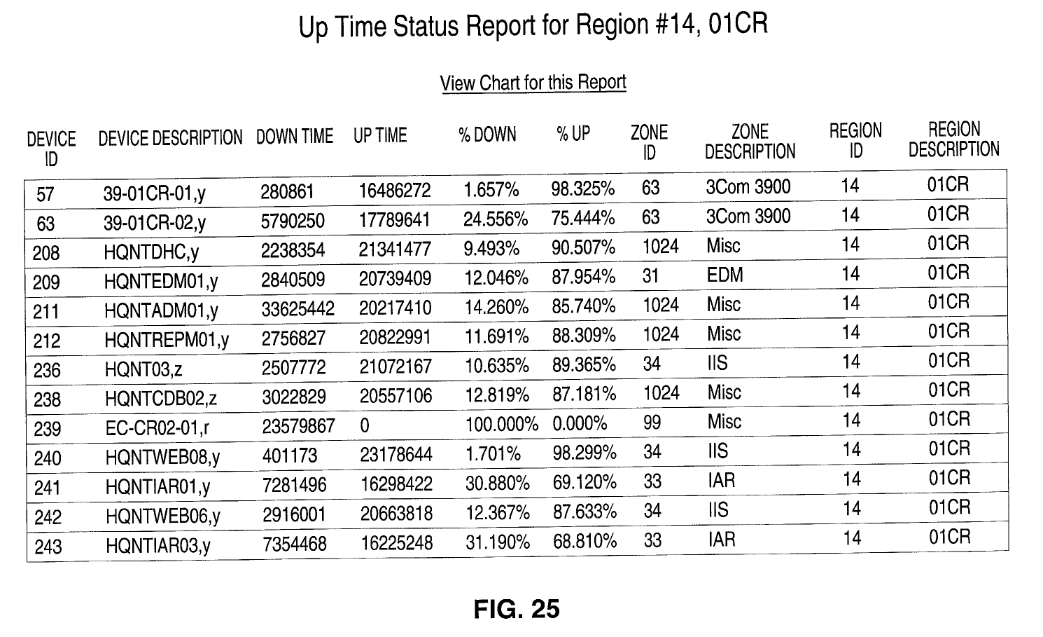

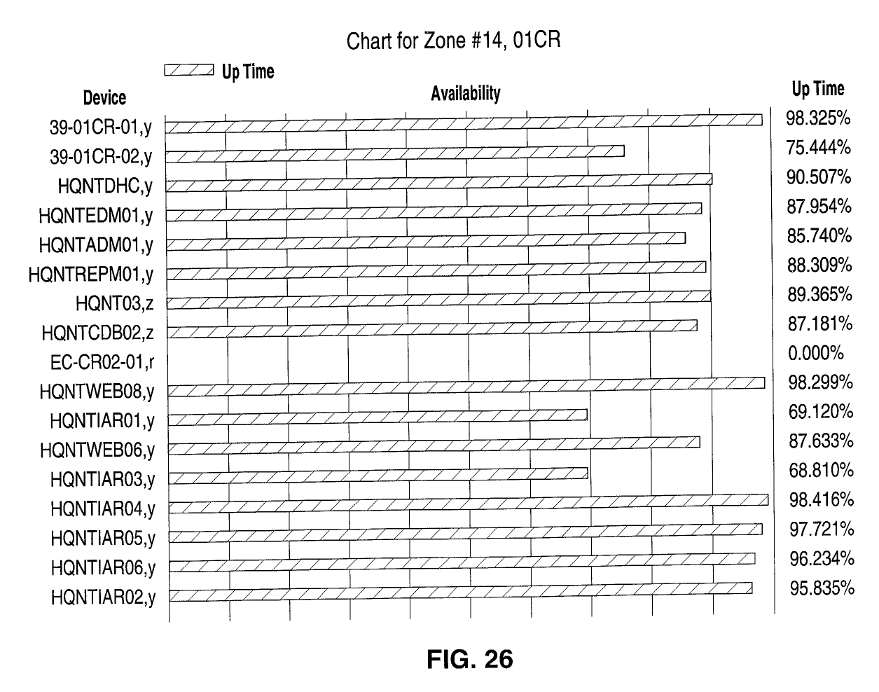

Reports on availability can be generated by the system for all monitored devices. Preferably, these reports are capable of providing “on-the-fly” information that includes the present status. A time period for the report is first selected, such as “Day”, “Week”, “Month”, or “All”, and the user then selects a report type. A variety of reports can be generated which preferably include a “Report by Location” and a “Report by Type”. Statistics may also be generated for devices, for example FIG. 25 illustrates an “Up-time Status Report for region #14, 01CR” screen which provides important information on up-time and down-time for a device, so that long-term device problems may be clearly identified. Clicking on the “View Chart for this Report” link within the report opens up a bar chart of FIG. 26, which more clearly illustrates the up-time relationships between the various devices. A number of additional reports exist within the system, and custom reports may be created so that the administrator is supplied with the information required to properly administer their specific network.

Upon concluding their use of the administration and monitoring system according to the present invention, the User or System Administrator preferably logs out to prevent subsequent system use by an unauthorized party.

10. Alternative Embodiments

One embodiment of the monitoring and administration system has been described and illustrated, however numerous uses and alternative embodiments may be considered without departing from the teachings of the present invention.

A remote monitoring facility which provides a mechanism for notifying personnel without regard to the functional status of the computer network was illustrated in FIG. 1. Although less preferred, it will be appreciated that the client network 12, without the benefit of the remote monitoring station 20, can provide notification functions according to the business rules. In such an embodiment, the administrator or an appointed user would perform the notification functions of an operator if warranted by the alert conditions. It will be appreciated that certain functions, such as email notification may be handled on the network while other notification methods or notification of certain parties is handled within the remote monitoring facility.

Within the described embodiment, port access is monitored for compliance according to a set of business rules, and it should be recognized that various aspects of the network can additionally, or alternatively, be monitored within the system. An example is the surveillance of web access ports on a system. Corporate intranets often include firewalls with web servers on their periphery for serving up web content and the handling of on-line transactions. It is important that these access points be operational while it is often difficult to assess the operation of the access points from within the company network. The remote network monitoring and administration system according to the present invention can be used to provide status monitoring and notification of business rule violations of web sites hosted by the corporation. It will be appreciated that extensions of the business rules can incorporate information and structural data about the web sites being hosted so that the serving of each page and specific page input/output functions therein can be surveyed against the business rules.

Accordingly, it will be seen that this invention of a method and system for real-time monitoring and administration of computer networks can be implemented with numerous variations obvious to those skilled in the art. In particular, numerous screen-shots are exemplified for the embodiment, and it will be appreciated that numerous variations may be implemented in the screens, the underlying databases, and the details of operation by one of ordinary skill in the art without departing from the present invention.

Although the description above contains many specificities, these should not be construed as limiting the scope of the invention, but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Edit Devices Screen - Button Definitions

| Button | Purpose |
|---|---|
| Submit | Enter additions or changes to a device entry within the |
| | database. Clicking Submit activates the change. |
| Editing Device | Display the device number typed into the field. |
| Prev | View the previous device. |
| Next | View the next device. |
| New | Define a new device at the next available device number. |
| Delete | Delete the currently displayed device number. |
| Index | Return to device index screen. |

TABLE 2
Edit Devices Screen - Field Definitions

| Field Name | Definition |
|---|---|
| Device Name | name and type of device (such as brand name) |
| Description | common description for the device |
| In Region, | physical and network location of the device |
| In Zone | (entered from Edit Regions and Zones screen) |
| Default | checked if all ports share information |
| Port Range | individual ports and ranges to which rules apply |
| Active | checked if the port range is active |
| IP Address | IP Address for device and ports |
| Description | common description of ports |
| Polling Period | defines frequency of polling |
| Retries | defines number of polling retries in the event the device |
| | or port does not respond |
| Timeout | defines number of seconds to wait for a polling reply |
| | before presuming no response is forthcoming |
| Backoff | defines number of additional seconds to wait before |
| | issuing a poll retry |
| Notify Rule | select the business rule which applies |

TABLE 3
Manage Region Tree - Button and Field Link Definitions

| Button | Purpose |
|---|---|
| Refresh View | Refresh the hierarchial display of the regions. |
| View by Zone | Change to “Manage Zone Tree” screen. |
| Collapse All | Collapse the extended regions back to single level |
| Add New | Define a new region into which devices may be grouped. |
| Region | |
| Move Region | Select region for moving. |
| Move Device | Select device for moving to another region. |
| Destination | Choose destination to move selected device or region. |

TABLE 4
Manage Zone Tree - Button and Field Link Definitions

| Button | Purpose |
|---|---|
| Refresh View | Refresh the hierarchial display of the regions. |
| View by | Change to “Manage Region Tree” screen. |
| Region | |
| Collapse All | Collapse the extended regions back to single level |
| Add New Zone | Define a new zone into which devices may be grouped. |
| Move Zone | Select zone for moving. |
| Move Device | Select device for moving to another zone |
| Destination | Choose destination to move selected device or zone. |

TABLE 5
Modify Business Rules screen - Button Definitions

| Button | Purpose |
|---|---|
| Submit | submit the entered additions/changes to a rule into the |
| | database and activate the changes |
| Prev | view previous rule |
| Next | view the next rule |
| New | create a new rule at subsequently available business rule |
| | number |
| Delete | delete the currently displayed business rule |
| Index | list the devices associated with the current rule, this opens |
| | a new screen |
| GOTO | display rule number typed into the adjoining text field |
| Clone From | Clone parameters from the selected device |

TABLE 6
Modify Business Rules screen - Field Definitions

| Field Name | Definition |
|---|---|
| Day boxes | days on which business rule is to be applied |
| Holidays box | if checked, rule applies only to holidays |
| Except Holidays | if checked, rule applies only to non-holidays |
| box | |
| All 24 Hours box | if checked, rule applies to the full 24 hrs. |
| | of the selected day |
| 6 am-6 pm box | if checked, rule applies during this time period |
| 6 pm-6 am box | if checked, rule applies during this time period |
| 8 am-5 pm box | if checked, rule applies during this time period |
| From: _ & To: _{—} | a period over which the rule is to apply |
| Escalation | time that device can be inoperative prior to escalation |
| Acknowledge | time notified user given to acknowledge the alert |
| Clear | time of normal functioning prior to alert clear |
| Notify Via | selection of the notification method |
| Notify User | selection of the user to be notified |
| Notify Address | selection of address for the user according to the |
| | notification method (i.e. Email notification requires |
| | an Email address, FAX notification a phone number) |

What is claimed is:

1. A system for monitoring the operations of a computer network from within a client server system which is operatively connected upon the computer network, comprising:
means for storing and retrieving operational information about ports and devices which are connected upon the computer network;
means for storing and retrieving business rules which describe intended operations of ports and devices operatively connected to the computer network;
means for storing and retrieving notification information which includes information about parties which are to be notified within each of a series of escalation levels;
means for surveying operations of the ports and devices in relation to the business rules; and
means for communicating alert notifications to personnel according to said notification information when the operation of the surveyed ports and devices contradict said business rules.

2. A method of monitoring the operations of a computer network by within the computer processor of a client server system operatively connected for communication on a computer network, comprising:
presenting rules of intended network operation, wherein the network operating rules describe a set of intended operational constraints for the behavior of ports and devices connected upon said network;
monitoring the actual operation of the ports and devices attached to said network in relation to the rules of network operation; and
providing alert notifications to a first list of personnel according to a first list of notification methods when the monitored operation of ports and devices contradict the rules of network operation.

3. A method as recited in claim 2, further comprising:
measuring the time from the issuance of the alert notification, which is cleared upon receipt of a proper response during the measurement interval; and
escalating the pending alert notification to a higher priority when the measured amount of time reaches a predetermined threshold, wherein the higher priority alert notification is performed according to a second list of personnel which is notified according to a second list of notification methods.

4. A method as recited in claim 3, wherein entries on said second list of personnel and said second list of notification methods is non-exclusive of the first notification list.

5. A method as recited in claim 2, further comprising remotely monitoring the network through a network connection to said client server system, wherein programming executable on said remote monitoring system receives information from said client server system over the network connection in response to alert notifications within the client server system and is capable of generating notifications according to a notification list when the monitored operation of ports and devices contradict the rules of network operation.

6. A system for monitoring the operations of a computer network from within a client server system connected to the computer network and capable of executing stored programs and of operatively storing and retrieving data, comprising:
(a) a database of port and device information capable of being operatively stored and retrieved by the client server system, wherein the port and device information describes operational aspects of the ports and devices, such as addressing, within the computer network;
(b) a database of business rules capable of being operatively stored and retrieved by the client server system, wherein the business rules describe desired operation of the ports and devices, such as times of operation, on the computer network;
(c) a notification list capable of being operatively stored and retrieved by the client server system, wherein the notification list describes parties to be notified and methods to be used in notifying said parties; and
(d) programming executable on said client server system which is capable of surveying the status and activity of the ports and devices within the network as defined within the device database on said computer network, wherein said programming is capable of reporting said activity and status to users of said client server system and is further capable of comparing said activity and status of the ports and devices against said database of business rules to generate alert notifications according to the notification list in response to violations of said business rules.

7. A system as recited in claim 6, wherein the database of device information comprises: port ranges of the device, an activity flag, a device address, and a device description.

8. A system as recited in claim 6, wherein said database of business rules comprises device and port operational times and configurations against which periodic surveys of the status and monitoring of the activity on said computer network is to be compared.

9. A system as recited in claim 6, further comprising programming which is executable on said client server system that provides for the modification of the business rules within said database.

10. A system as recited in claim 6, wherein said database of business rules incorporates said notification list.

11. A system as recited in claim 6, wherein the notification list further comprises escalation levels, and the programming which is executable on said client server is responsive to said escalation levels by notifying disparate portions of the notification list as operations and status on the network continue in contradiction to said business rules.

12. A system as recited in claim 6, wherein the programming executable on said client server accepts modification of the business rules within said database in real-time such that at the time the change is made to the business rule database monitoring activity of the system changes accordingly.

13. A system as recited in claim 6, further comprising a remote monitoring system comprising:
(a) a network connection to said client server system;
(b) a communications interface; and
(c) programming executable on said remote monitoring system which receives information from said client server system over the network connection in response to alert notifications within the client server system and is capable of generating notifications on the communications interface according to the notification list of the client server system.

14. A system as recited in claim 13, further comprising a service console which allows a service operator to view incoming alert notifications and elect a course of notification and remediation for any particular computer network being monitored.

15. A system for monitoring operation of a computer network, comprising:
(a) a client server connected on the computer network having a database of device information and business rules along with programming operable on said client server for monitoring devices on the network according to the database and comparing the operation of said devices against said business rules and generating alert notifications in response to violations thereof, programming operable on the client server is further capable of providing for the display of status and violation information about monitoring of the computer network; and
(b) a communications interface associated with said client server for communicating alert notifications externally from the computer network to a remote monitoring device.

16. A system as recited in claim 15, wherein information on each device is retained within the business rule and is selected from the group consisting of port ranges, active flag, IP address, description, polling period, timeout, back-off, and selection of notification rule.

17. A system as recited in claim 15, wherein said database of business rules comprises device and port operational times and configurations against which periodic status of said computer network is to be compared such that excursions therebetween are capable of being translated into alert notifications generated and communicated to users specified within the business rules so that the excursion may be timely corrected.

18. A system as recited in claim 17, wherein the predetermined methods for sending notification is selected from the group consisting of facsimile, pager, e-mail, telephone, couriers, and other means of communication.

19. A system as recited in claim 17, wherein the alerts are generated within escalation levels, each escalation level having an association of parties which are to be notified, whereupon an alert not responded to within the predetermined time period escalates to the next level such that a new list of parties is notified regarding the alert.

20. A system as recited in claim 19, wherein each escalation level contains information about the parties to be contacted and the timing of the notification escalation.

21. A system as recited in claim 20, wherein the information contained within the escalation level is selected from the group consisting of party to notify, method of notification, and values for escalation time, acknowledgement time, and clear time.

22. A system as recited in claim 15, further comprising a network monitoring server having means for communicating with said client server.

23. A system as recited in claim 15, wherein the programming for interacting with said business rules in real time comprises a series of screens for status, setting of device information, and the setting of escalation levels.

24. A system for monitoring the operations of a computer network, comprising:
(a) a client server system connected to the computer network comprising,
(i) an interface for communicating with devices on said computer network,
(ii) a database containing device information about devices on the computer network,
(iii) a database containing business rules about the intended operation of the computer network,
(iv) a notification list having escalation levels so that escalating levels of notification can be provided according to a set of notification methods when contacting personnel to communicate alert notifications,
(v) programming executable on said client server which provides for the modification of device information and business rules within said databases,
(vi) programming executable on said client server which monitors devices on said computer network as defined within said device information database and compares computer network operation against said database of business rules, generating an alert notification for operations that violate said business rules and capable of generating notifications to personnel by said set of notification methods according to the notification list and escalation levels, and
(vii) an external communications interface;
(b) a remote monitoring system comprising,
(i) communication interfaces for providing notification of personnel,
(ii) an operator interface, and
(iii) programming executable on said remote monitoring system which receives alert notifications from said client, identifies those alert notifications, and provides for intervention and intercession by a human operator on the operator interface for the generation of human directed alert notifications to personnel from a remote location.

25. A system as recited in claim 24, wherein said business rule database includes said notification list.

26. A system as recited in claim 24, wherein said database of business rules comprises device and port operational times and configurations against which periodic status of said computer network is to be compared such that excursions therebetween are capable of being translated into alerts generated and communicated to users so that the excursion may be timely corrected.

27. A system as recited in claim 24, wherein the alerts are generated within an enumeration of escalation levels, each escalation level having an association of parties which are to be notified, whereupon an alert not responded to within the predetermined time period escalates to the next level such that a new list of parties is notified regarding the alert.

28. A system as recited in claim 25, wherein the alert is generated through a communications medium that is selected from the group of communication media consisting of Email, voice telephone, facsimile, cellular phone, pager, radio-links, lightwave-links, couriers, and postal carrier services.

29. A method of monitoring operations on a client network, comprising:
defining the characteristics of devices to be monitored on the client network;
defining client network operational constraints as a set of business rules;
defining a notification list with escalation levels and escalation rules, the notification list defining notification information for personnel that are to be notified when network operations contradict the set of business rules, the escalation rules defining movement between portions of the notification list which are divided into escalation levels so that alert notifications may be generated with higher priority business rule contradiction continues;
periodically monitoring the devices within the client network according to the business rules and the generation of alert notifications in response to contradictions thereof;
communicating said alert notification according to said notification list such that parties within the notification list are contacted and notified; and
increasing escalation levels when escalation rules are met, and resetting the notifications when a proper response has been received.

30. A system for monitoring the operations of a computer network from within a client server system which is operatively connected upon the computer network, comprising:
(a) a computer; and
(b) programming associated with said computer for carrying out the operations of
(i) storing and retrieving operational information about ports and devices which are connected upon the computer network;
(ii) storing and retrieving business rules which describe intended operations of ports and devices operatively connected to the computer network;
(iii) storing and retrieving notification information which includes information about parties which are to be notified within each of a series of escalation levels;
(iv) surveying operations of the ports and devices in relation to the business rules; and
(v) communicating alert notifications to personnel according to said notification information when the operation of the surveyed ports and devices contradict said business rules.
